(19) United States
(12) Patent Application Publication
(10) Pub. No.: US 2011/0033687 A1
(43) Pub. Date: Feb. 10, 2011

(54) THIN WOVEN FABRIC

(76) Inventor: Junko Deguchi, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/989,366

(22) PCT Filed: Apr. 24, 2009
(86) PCT No.: PCT/JP2009/058138

§ 371 Date: Oct. 22, 2010

(30) Foreign Application Priority Data
Apr. 25, 2008 (JP) 2008-115447

(51) Int. Cl. D03D 15/00; B32B 27/34; B32B 27/36; D06M 15/643

(52) U.S. Cl. 428/219; 442/164; 442/168

(57) ABSTRACT

Disclosed is a thin woven fabric wherein thermoplastic synthetic fibers of fineness from 5 to 30 dtex are disposed in at least some of the warp and weft threads of a woven fabric and the number of intersections of the warp and weft threads of said woven fabric is from 23000 to 70000/2.54 cm². Said woven fabric in the thin woven fabric is subjected to a silicone resin treatment.

### TECHNICAL FIELD

The present invention relates to a thin woven fabric used for a ticking of down jackets, sports garments made of a thin fabric such as windbreakers, and a ticking for sleeping bags and futons or a woven fabric for the inner bags of sleeping bags and futons. More specifically, the present invention relates to a thin woven fabric that is lightweight and very thin while having high tear strength and abrasion strength, and to sports garments, tickings for futons, or a woven fabric for an inner bag for which the thin woven fabric is used.

### BACKGROUND ART

Conventionally, it has been desired that woven fabrics for sports garments are lightweight and thin from the viewpoint of easier movement while having high tear strength. It has also been desired that fabrics are lightweight and thin and keep tear strength in order to reduce load during sleep and load of taking out and taking back a futon in application to futon tickings such as futon covers and futon inner bags, or in order to use such a fabric in application to sleeping bags. However, in the case where the fineness of the yarn that forms the woven fabric was made small to make the woven fabric lightweight and thin, there were problems that tear strength and abrasion strength were also reduced so that such a fabric was not for practical use. In addition to lightweightness and thinning of the fabric, down proof properties are required particularly in the case of the fabrics for down jackets among the sports garments, sleeping bags, tickings for down comforters, and inner bags for down comforters. However, in order to satisfy down proof properties, the woven fabric has needed to have a dense structure, leading to a problem that the woven fabric has become hard.

Patent document 1 has disclosed a woven fabric that has a fineness of 25 dtexes (decitexes) or less, is used as a ticking for wadiing, and is not resin treated. However, in the case of the woven fabric using a yarn of 25 dtexes or less and not treated with a silicone resin, tear strength can be 8 N or more in the case where a woven fabric is made of polyamide fibers as described in Patent Document 1. However, for example, in the case where polyester fibers are used, which is not the case disclosed in Patent Document 1, there has been a problem that it is difficult to obtain tear strength of the woven fabric of 8 N or more. Further, Patent Document 1 has described a woven fabric having a fineness of 22 dtexes. However, it is disclosed that a woven fabric with 10 dtexes has small tear strength, for example. Accordingly, no woven fabric having a fineness smaller than 22 dtexes and having sufficient tear strength has been disclosed.

### PRIOR ART

### Patent Document

PATENT DOCUMENT 1: JP 2005-48298 A

### DISCLOSURE OF INVENTION

### Technical Problem

An object of the present invention is to provide a sports garment, a futon ticking, or a woven fabric for an inner bag that is very light weight and thin while having high tear strength and abrasion strength, and to solve a problem that tear strength and abrasion strength are small in the case where a woven fabric is produced using a very fine yarn.

### Technical Solution

In order to solve the above-mentioned problem, the present inventor has found out that even a thin lightweight woven fabric has sufficient tear strength by using a fine fiber having a specific small fineness, controlling the number of intersections between warps and wefts in a woven fabric in a specified range, and applying resin treatment with a silicone resin, whereby the present invention has been accomplished.

Namely, the present invention is as follows.

b 1) A thin woven fabric, comprising a thermoplastic synthetic fiber having a fineness of 5 to 30 dtexes disposed in at least a part of warps or wefts of the woven fabric, wherein a number of intersections between the warps and the wefts of the woven fabric is 23000 to 70000 pieces/(2.54 cm²), and silicone resin treatment is applied on the woven fabric.
(2) The thin woven fabric according to (1), wherein the thermoplastic synthetic fiber is a polyester synthetic fiber or polyamide synthetic fiber having a single yarn fineness of 0.5 to 2.5 dtexes.
(3) The thin woven fabric according to (1) or (2), wherein the thermoplastic synthetic fiber is a polyester fiber having an intrinsic viscosity [η] of 0.65 to 1.30.
(4) The thin woven fabric according to (1) or (2), wherein the thermoplastic synthetic fiber is a polyamide fiber having a relative viscosity of 2.5 to 3.5.
(5) The thin woven fabric according to any one of (1) to (4), wherein a basis weight of the woven fabric is 15 to 50 g/m².
(6) The thin woven fabric according to any one of (1) to (5), wherein permeability of the woven fabric is 0.3 to 1.5 cc/cm²·sec.
(7) The thin woven fabric according to any one of (1) to (6), wherein tear strength of the woven fabric is 8 to 20 N.
(8) The thin woven fabric according to any one of (1) to (7), wherein a structure of the woven fabric is a ripstop structure.
(9) The thin woven fabric according to (8), wherein a proportion of unconstrained points is 2 to 40% in the intersections between the warps and the wefts of the woven fabric.
(10) The thin woven fabric according to any one of (1) to (9), wherein abrasion strength of the woven fabric is 10000 times or more.
(11) The thin woven fabric described in any one of (1) to (10), the silicone resin treatment is performed by a DIP-NIP method.
(12) The thin woven fabric according to any one of (1) to (11), wherein an amount of the silicone resin to be attached is 0.1 to 10.0% by weight.

### Advantageous Effects of Invention

A thin woven fabric according to the present invention is a very thin woven fabric that is very light weight and thin while having high tear strength and abrasion strength, and is soft and has down proof properties. The thin woven fabric is suitable for down jackets, sports garments such as windbreakers, tickings of sleeping bags and futons, or a woven fabric for inner bags thereof.

### BRIEF DESCRIPTION OF DRAWINGS

FIG. 1 shows a structural diagram (FIG. 1A) of a woven fabric according to the present invention, and a diagram of an example showing an overlapping state of yarns (FIG. 1B, FIG. 1C);

FIG. 2 shows a structural diagram of a woven fabric according to Example 2; and

FIG. 3 shows a structural diagram of a woven fabric according to Example 3.

### DESCRIPTION OF EMBODIMENTS

A thin woven fabric according to the present invention is a thin woven fabric comprising a thermoplastic synthetic fiber of a fineness 5 to 30 dtexes disposed in at least a part of warps or wefts of the woven fabric. The thermoplastic synthetic fiber may be disposed in one of the warps and the wefts, or may be disposed in both of the warps and the wefts. The thermoplastic synthetic fiber in the present invention is not particularly limited, and polyester fibers, polyamide fibers, polyolefin fibers, or the like are suitably used. Examples of the polyester fibers include polyethylene terephthalate, polytrimethylene terephthalate, polybutylene terephthalate, polyethylene naphthalate, copolymerized polyester fibers made of these as a principal component. Examples of the polyamide fibers include those obtained by copolymerizing Nylon 6, Nylon 66, and a third component. Examples of the polyolefin fibers include polypropylene and polyethylene and so on. Of these, the polyester fibers are particularly preferable from the viewpoint of heat resistance and dyeing properties, and the polyamide fibers are preferable from the viewpoint of softness. Fibers other than the thermoplastic synthetic fiber may be used in part.

The thermoplastic synthetic fiber used for the woven fabric according to the present invention preferably has a large molecular weight. Because the molecular weight of the polymer that forms the fiber can usually be represented with a viscosity, the viscosity is desirably high. For example, in the case of the polyester fiber, the intrinsic viscosity [η] is preferably 0.65 to 1.30, and more preferably 0.8 to 1.1. Here, the intrinsic viscosity [η] refers to a limiting viscosity measured at 1% by weight of the polymer in orthochlorophenol. At an intrinsic viscosity [η] of 0.65 to 1.30, even the polyester fiber having a small yarn fineness, which is used for the present invention, can obtain a target tear strength. At an intrinsic viscosity [η] of 0.65 or more, yarn strength and abrasion strength of the yarn are large, and tear strength and abrasion strength for a woven fabric which is made of a yarn having a particularly small single yarn fineness are also sufficient. At an intrinsic viscosity [η] of 1.3 or less, a problem hardly occurs that the feeling is hard in the case where a woven fabric is made of such a yarn. The polyester fiber having an intrinsic viscosity [η] of 0.65 to 1.30 is preferably used for the warps or the wefts. More preferably, the polyester fiber is used for both of the warps and the wefts.

Moreover, in the case of the polyamide fiber, the relative viscosity is preferably 2.5 to 3.5. The relative viscosity here is a viscosity obtained by dissolving a polymer or a prepolymer in 85.5% special grade concentrated sulfuric acid as a polymer concentration of 1.0 g/dl, and measuring the relative viscosity of the solution using an Ostwald viscometer at 25° C. At a relative viscosity of 2.5 or more, yarn strength and abrasion strength of the yarn are large, and tear strength and abrasion strength for a woven fabric which is made of a yarn having particularly a small fineness are also sufficient. At a relative viscosity of 3.5 or less, a problem hardly occurs that the feeling is hard in the case where a woven fabric is made of such a yarn. The polyamide fiber having a relative viscosity of 2.5 to 3.5 is preferably used for the warps or the wefts. More preferably, the polyamide fiber is used for both of the warps and the wefts.

The fineness of the fibers disposed in a part of the warps or the wefts of the woven fabric according to the present invention needs to be 5 to 30 dtexes. Preferably, it is 8 to 25 dtexes. At a fineness exceeding 30 dtexes, the yarn is thick, and in the case where the woven fabric is made of such a yarn, the woven fabric is thick and hard, thereby making it impossible to attain the object of the present invention. At a fineness less than 5 dtexes, it is difficult to obtain tear strength of 8 N or more even if the structure of the woven fabric is adjusted and applied with resin treatment. In the case of the polyester fiber, the fineness of 18 dtexes or less is more preferable. In the case of the polyamide fiber, the fineness of less than 15 dtexes is more preferable. The single yarn fineness is preferably 0.5 to 2.5 dtexes, and more preferably 0.7 to 2.0 dtexes.

While the shape of the single yarn cross section of the fiber used for the woven fabric according the present invention is not particularly limited, a modified cross-section yarn having a degree of cross-section modification of 2 to 7 is preferable. Particularly, in the case where W-shaped cross section fibers or V-shaped cross section fibers are formed into a woven fabric, the fibers are disposed so as to have the so-called brick masonry structure, and show a structure similar to a closest packed structure. For that reason, a gap between a single yarn and a single yarn can be reduced to reduce permeability. Accordingly, the above-mentioned modified cross-section fibers are preferable. Moreover, use of the single yarn having a flat shape such as a W-shaped cross section provides a woven fabric with a soft feeling due to the effect of reducing bending stress by the yarn.

In the case where the modified cross-section fiber having a W cross section, a V cross section, an eyeglasses-shaped cross section, or the like has a shape having a groove, i.e., a concavity in a single yarn cross section, sweat-absorbing and quick-drying properties as a woven fabric are excellent. For that reason, such a fiber is formed into a woven fabric for garments, futon tickings, or the like that is not sticky if a user sweats, and is preferable.

The above-mentioned thermoplastic synthetic fiber may be used for at least a part of the warps or the wefts of the woven fabric, or the entire woven fabric may be formed of this yarn.

The woven fabric according to the present invention preferably has a basis weight of 15 to 50 g/m². More preferably, the base weight thereof is 35 g/m² or less. The basis weight may be 50 g/m² or less in order to feel lightweightness when the woven fabric is used for sports garments, futon tickings, particularly tickings for down jackets and down comforters. At a basis weight of 15 g/m² or more, tear strength can be 8 N or more by adjusting the structure of the woven fabric and applying resin treatment.

Preferably, the woven fabric according to the present invention is lightweight and thin, but has high tear strength. Tear strength in the present invention is measured with the JIS-L-1096: 8.15.5 D method (a pendulum method). Tear strength is preferably 8 N to 20 N in order for the woven fabric to be put into practical use as sports garments, and futon tickings, for example. At a tear strength of 8 N or more, the woven fabric may not be torn in use. Moreover, tear strength of 20 N or less enables a thin woven fabric using the fine yarn of the present invention, and is useful in practical use.

In order to obtain tear strength of 8 N to 20 N while the woven fabric is lightweight and thin, the woven fabric according to the present invention is characterized by having a specific structure, and moreover, by being subjected to resin treatment with silicone. It has been conventionally thought that there are problems that resin treatment makes a feeling hard or deteriorates durability. However, in the present invention, it is found out that tear strength of the woven fabric is remarkably improved by applying silicone resin treatment on such a dense woven fabric having a small fineness, and additionally, a resin coated film having a soft feeling and high durability can be given. This is because the silicone resin improves slip properties of fibers having a small fineness in the present invention, while conventional resin treatment mainly aims at forming a coating on a fabric surface.

A silicone resin treatment agent is not particularly limited as long as it is a resin containing silicone. From the viewpoint of durability and processability, however, an emulsion of a modified silicone resin and a surfactant is particularly preferable. Specific examples of the modified silicone include, but not limited to, NICCA SILICONE DM-100E made by Nicca Chemical Industry & Co., Ltd., Sirikoran EC and Parajin MB made by Keihin Kagaku K.K., Haisofuta KR-50 made by Meisei Chemical Works, Ltd., and Solusoft WA made by Clariant (Japan) K.K. The surfactant can be properly selected in consideration of ionicity of the silicone resin.

A reason that tear strength is improved by applying the silicone resin treatment onto the thin woven fabric is attributed to improvement in slip properties of the yarn by silicone resin treatment. Usually, in tearing of the woven fabric, the woven fabric is torn with relatively small stress when the stress concentrates on a point to be torn. On the other hand, the stress at the point to be torn is dispersed by slip properties of the yarn given by silicone resin treatment so that tear strength can be 8 N or more.

This slip effect of the yarn is different depending on the structure of the woven fabric. As another feature of the present invention, the number of intersections between the warps and the wefts of the woven fabric is 23000 pieces/inch² to 70000 pieces/inch², and preferably 27000 pieces/inch² to 62000 pieces/inch². The number of intersections between the warps and the wefts of the woven fabric in the present invention refers to the number of points at which the warps and the wefts intersect in a 1-inch square, and can be expressed with warp density (the number of warps/inch)×weft density (the number of wefts/inch) in the case of taffeta and ripstop taffeta. In the case where the number of intersections between the warps and the wefts is less than 23000 pieces/inch², gaps of the yarns in the woven fabric is larger, and it is difficult to control permeability at 1.5 cc/cm²·sec or less. Seam slippage resistance is reduced, and a problem may occur also in sewability. At the number of intersections between the warps and the wefts of more than 70000 pieces/inch², the feeling is hard, and tear strength is not improved even by applying resin treatment so that it is hard to achieve the goal of the present invention.

Further, in the present invention, the proportion of unconstrained points is preferably in the range of 2% to 40% in the intersections between the warps and the wefts of the woven fabric. More preferably, it is 4% to 35%. The intersections in the woven fabric are classified into a constrained point and an unconstrained point.

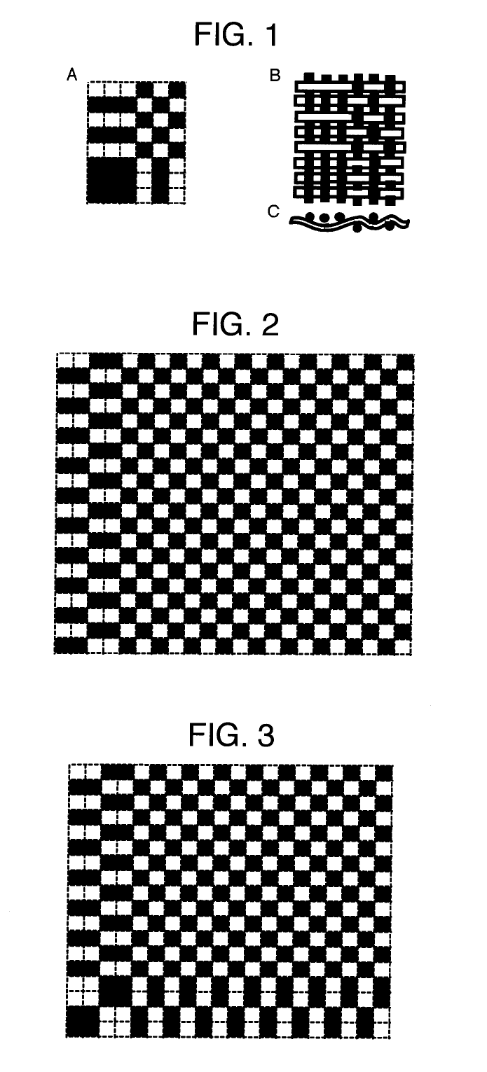

The constrained point here refers to a point at which the warp and the weft intersect, and the unconstrained point refers to a portion in which the warps or the wefts are disposed side by side. Hereinafter, a structure of the woven fabric in FIG. 1 will be described as an example. In the structural diagram of the woven fabric, the color of black expresses an intersection at which the warp comes out on the front side, and the color of white expresses an intersection at which the weft comes out on the front side. FIG. 1B shows overlapping of the warps and the wefts of FIG. 1A. Moreover, viewed from a cross sectional direction, overlapping of the yarns in the lowermost row in FIG. 1B is as shown in FIG. 1C. The unconstrained point means a case where the warps or the wefts are disposed side by side. In FIG. 1A (FIG. 1B), in the case of the lowermost row, the warps are disposed side by side at two places on the left side, and the unconstrained points are 2 and the constrained points are 4. Each of the eight lines in FIG. 1A has two unconstrained points. Accordingly, the unconstrained points are 16, and the constrained points are 32 in the latitudinal direction. Similarly, in the leftmost column, lower two places are unconstrained points. Accordingly, the unconstrained points are 2 and the constrained points are 6. Because every column is similar, the unconstrained points in the longitudinal direction are 12 and the constrained points are 36. Accordingly, in 96 intersections per unit structure, the number of the unconstrained points is 28, and the proportion of the unconstrained points is 29.2%. Action of the silicone resin to the unconstrained points increases the slip effect dramatically, and makes it easy to disperse the stress upon tearing. As a result, tear strength can be enhanced although the fineness is small. The woven fabric having such a small fineness as the present invention inevitably has a high density, and includes many constrained points. However, in the present invention, a degree of freedom of the yarn can be enhanced by giving the unconstrained points in a specific proportion so that tear strength can be enhanced. Further, in order to enhance the slip effect upon tearing, the unconstrained points are made to exist densely or collectively particularly in the woven fabric using the yarn having an extremely small fineness and the woven fabric whose basis weight is extremely small. Thereby, the degree of freedom as a collection region is increased, and tear can be enhanced. Namely, a structure having 2 to 3 continuous unconstrained points is effective.

Particularly in the case where the woven fabric according to the present invention is used for tickings for down jackets or down comforters, permeability is preferably 0.3 to 1.5 cc/cm²·sec in order to satisfy down proof properties. In order to obtain lightweightness and control permeability at 0.3 to 1.5 cc/cm²·sec, it is necessary to produce a dense woven fabric with a fine yarn. For that reason, the woven fabric tends to be a hard woven fabric having a structure less movable. By providing a structure in which 2 to 3 unconstrained points are continuous, a woven fabric that is lightweight and has low permeability while having high tear strength can be obtained. Particularly preferably, the permeability is 0.5 to 1.0 cc/cm²·sec.

The slip effect is not reduced when the proportion of the unconstrained points is 2% or more of the intersections in the woven fabric. At a proportion of the unconstrained points of 40% or less, seam slippage resistance is also increased, and no problem occur in sewability.

The woven structure of the woven fabric according to the present invention is not particularly limited, and an arbitrary structure such as ripstop taffeta, a twill structure, and a satin structure can be used. Of these, particularly, the ripstop taffeta has the unconstrained points, and thus is suitably used. In the case of the ripstop taffeta, the specificity of the woven structure and an action of the silicone resin demonstrate a synergistic effect of each other, and large improvement such as 30 to 50% improvement in tear strength is shown compared to the fabric without a resin. In the case of the ripstop taffeta structure, 2 to 3 yarns are multiply arranged for the warps or the wefts. Thereby, a significant slip effect by the silicone resin is remarkably produced. For that reason, it seems that such an excellent effect is produced. The size of a lattice pattern of the ripstop is preferably 0.2 to 5 mm.

The amount of the silicone resin to be attached in order to demonstrate the slip effect is preferably 0.1 to 10.0% by weight based on the fabric. Particularly, 0.5 to 3.0% by weight is preferable because other drawbacks such as distortion hardly occur. At an amount of the silicone resin to be attached in this range, tear strength is 10 to 50% increased compared to the case where no silicone resin is used.

A method for resin treatment is not particularly limited, and a method for treatment by a DIP-NIP method after dyeing, a method for treatment with an exhaust method, and a method for treatment by mixing a resin in a coating agent, for example, are suitably used. From the viewpoint of attaching a treatment agent firmly to the fabric surface at a final stage of the treatment step, the method for treatment by the DIP-NIP method is particularly suitably used. A drying temperature can also be an ordinary finishing temperature for the woven fabric without a particular problem.

In addition to the effect of improving tear strength, by applying silicone resin treatment, an effect of making the feeling smooth and soft can also be achieved simultaneously. By this effect, a rough feeling is eliminated, and the texture becomes good in the case where the woven fabric is used as sports garments and a futon ticking.

The thin woven fabric according to the present invention excels in abrasion strength in addition to tear strength. Abrasion strength is evaluated by a Martindale abrasion method in which a partner cloth for abrasion is replaced by hair canvas. When the woven fabric has abrasion strength of 10000 times or more and more preferably of 15000 times or more in this method, it can be said that the woven fabric has sufficient durability also in the case where it is used for sport application such as down jackets and windbreakers. In order to enhance abrasion strength while the woven fabric is thin, a method for using high-viscosity polyamide or polyester fibers to control the single yarn fineness preferably at 0.5 dtexes to 2.5 dtexes and more preferably at 0.7 dtexes to 2.5 dtexes is effective. It is also effective to perform heat relaxation on the yarn or the woven fabric.

A weaving machine used at the time of weaving the woven fabric is not particularly limited, either. Water jet loom weaving machines, air jet loom weaving machines, and rapier looms can be used. The woven fabric after weaving is scoured, relaxed, preset, and dyed according to the conventional method. A water-repellent treatment, a water absorbing process, processes to give function such as antimicrobial properties, and deodorization, and a post processing such as a coating process and calendering can be added when necessary.

The thus-obtained woven fabric has features such that the weight thereof is lighter, and tear strength and abrasion strength are larger than those of the conventional woven fabrics for sports garments or futon tickings, and the feeling is also smooth and soft. Further, permeability can be reduced so that the woven fabric can also have down proof properties.

### EXAMPLES

The present invention will be described based on Examples. Measurement parameters and methods used in Examples are as follows.

### (1) Polymer Viscosity of Fiber

In the case of a polyester fiber: an intrinsic viscosity [η] was shown as a limiting viscosity measured at 1% by weight in orthochlorophenol.

In the case of a polyamide fiber: a relative viscosity was measured as follows: a polymer or a prepolymer was dissolved in 85.5% special grade concentrated sulfuric acid as the polymer concentration of 1.0 g/dl, and the relative viscosity of the solution was measured using an Ostwald viscometer at 25° C.

### (2) Basis Weight

The basis weight was determined based on the according to JIS-L-1096 8.4.2 Mass per unit area of woven fabric under standard condition.

### (3) Tear Wtrength

Tear strength was measured according to the JIS-L-1096 8.15.5 D method (the pendulum method).

### Unit is N.

(4) Abrasion Wtrength Abrasion strength was measured according to the JIS-L-1096 8.17.5 E method (the Martindale method) except that the partner cloth for abrasion was replaced by hair canvas. The number of times of abrasion until a hole was produced or an abrasion rate reached 5% or more was measured.
(5) Permeability Permeability was measured according to the JIS-L-1096 8.27.1 A method (a fragile method). Unit is cc/cm²·sec.

### (6) Degree of Cross-Section Modification

A photograph of a cross section of the woven fabric was taken. From the photograph of the cross section, the degree of cross-section modification was calculated by large diameter (diameter of the longest portion)/small diameter (diameter perpendicular to the large diameter) of the cross section of a single yarn fiber that forms the woven fabric.

### (7) Presence/Absence of Silicone Resin Treatment

Presence of treatment was expressed as “yes,” and absence of treatment was expressed with “no.”

### (8) Feeling of Ffabric (Softness)

The feeling of the fabric was determined as an average of sense evaluations of five persons (1: hard, 2: a little hard, 3: not determined to be hard or soft, 4: a little soft, 5: soft).

### Example 1

Using a polyester filament having an intrinsic viscosity [η] of 0.85, 11 decitexes, and 10 filaments as warps and wefts, a woven fabric having a ripstop structure in FIG. 1 was woven with a water jet loom weaving machine. According to the conventional method, the obtained woven fabric was scoured and preset, and subsequently dyed with a jet dyeing machine and dried. Then, an emulsion of 1% of NICCA SILICONE DM-100E made by Nicca Chemical Industry & Co., Ltd. as a modified silicone resin and 0.5% of an anionic surfactant was applied to the woven fabric by the DIP-NIP method, and dried at 140° C. Then, heat calendering at 160° C. was performed. The amount of the silicone resin to be attached was 0.8% by weight.

The properties of the obtained woven fabric were as shown in Table 1. Namely, the basis weight of the woven fabric was 32 g/m², the number of intersections between the warps and the wefts was 60025 pieces/inch², the proportion of unconstrained points was 29.2%, and tear strength in the lengthwise direction was 10.5 N, and tear strength in the transverse direction was 12 N.

The feeling of the fabric was very good. When this woven fabric was used for down jackets, it was lightweight, thin, and soft, and also had sufficient strength.

### Example 2

Weaving and treatment were performed with the same method as described in Example 1 except that weaving was performed so as to have a structure of FIG. 2 using a polyester filament having a W-shaped cross section with an intrinsic viscosity [η] of 0.87, 17 decitexes, 18 filaments, and a degree of cross-section modification of 3.2 as warps and wefts.

The properties of the obtained woven fabric were as shown in Table 1. Namely, the basis weight of the woven fabric was 31 g/m², the number of intersections between the warps and the wefts was 44000 pieces/inch², the proportion of unconstrained points was 4.5%, and tear strength in the lengthwise direction was 9.1 N, and tear strength in the transverse direction was 8.2 N.

The feeling of the fabric was very good. When this woven fabric was used for down jackets, it was lightweight, thin, and soft, and also had sufficient strength.

### Example 3

Weaving and treatment were performed with the same method as described in Example 1 except that weaving was performed so as to have a structure of FIG. 3 using a polyester filament having a W-shaped cross section with an intrinsic viscosity [η] of 0.87, 24 decitexes, 18 filaments, and a degree of cross-section modification of 3.2 as warps.

The properties of the obtained woven fabric were as shown in Table 1. Namely, the basis weight of the woven fabric was 37 g/m², the number of intersections between the warps and the wefts was 30960 pieces/inch², the proportion of unconstrained points was 10.6%, and tear strength in the lengthwise direction was 10.1 N, and tear strength in the transverse direction was 11 N. When this woven fabric was used for down jackets, it was lightweight, thin, and soft, and also had sufficient strength.

### Example 4

Weaving and treatment were performed with the same method as described in Example 1 except that a Nylon 66 filament having a round cross section with a relative viscosity of 2.8, 24 decitexes, and 26 filaments was used for the warps and the wefts and the woven structure was a 2/1 twill.

The properties of the obtained woven fabric were as shown in Table 1. Namely, the basis weight of the woven fabric was 38 g/m², the number of intersections between the warps and the wefts was 27200 pieces/inch², the proportion of unconstrained points was 33.3%, and tear strength in the lengthwise direction was 10 N, and tear strength in the transverse direction was 11 N.

The feeling of the fabric was very good. When this woven fabric was used for down jackets, it was lightweight, thin, and soft, and also had sufficient strength.

### Example 5

Weaving and treatment were performed with the same method as described in Example 1 except that a Nylon 66 filament having a round cross section with a relative viscosity of 3.1, 15 decitexes, and 13 filaments was used for the warps and the wefts.

The properties of the obtained woven fabric were as shown in Table 1. Namely, the basis weight of the woven fabric was 33 g/m², the number of intersections between the warps and the wefts was 52900 pieces/inch², the proportion of unconstrained points was 29.2%, and tear strength in the lengthwise direction was 8.5 N, and tear strength in the transverse direction was 9 N.

The feeling of the fabric was very good. When this woven fabric was used for down jackets, it was lightweight, thin, and soft, and also had sufficient strength.

### Example 6

Weaving and treatment were performed with the same method as described in Example 1 except that a polyester filament having an intrinsic viscosity [η] of 0.85, 11 decitexes, and 24 filaments was used for the warps and the wefts.

The basis weight of the obtained woven fabric was as light as 25 g/m². Permeability was 0.7 cc/cm²·sec, and down proof properties were provided. On the other hand, tear strength was less than 8 N.

### Example 7

Weaving and treatment were performed with the same method as described in Example 1 except that a polyester filament having an intrinsic viscosity [η] of 0.62 was used for the warps and the wefts.

The basis weight of the obtained woven fabric was as light as 30 g/m². Permeability was 0.7 cc/cm²·sec, and down proof properties were provided. On the other hand, tear strength was less than 8 N.

### Comparative Example 1

The same woven fabric as described in Example 2 was woven and dyed. Then, calendering was performed, without performing silicone resin treatment.

The basis weight of the obtained woven fabric was 30 g/m², while tear strength was less than 8 N. Moreover, the feeling was rough.

### Comparative Example 2

Weaving and treatment were performed with the same method as described in Example 1 except that a polyester filament having an intrinsic viscosity [η] of 0.83, 34 decitexes, and 24 filaments was used for the warps and the wefts.

As a result, the basis weight of the obtained woven fabric was as heavy as 40 g/m². The number of intersections between the warps and the wefts was 19180 pieces/inch², and permeability was large. Seam slippage resistance was small.

### Comparative Example 3

Weaving and treatment were performed with the same method as described in Example 1 except that a weaving density was 280/inch in the longitudinal direction and 270/inch in the latitudial direction.

The basis weight of the obtained woven fabric was 34 g/m², while tear strength was less than 8 N. Moreover, the feeling was hard.

TABLE 1

| | | Example 1 | Example 2 | Example 3 | Example 4 | Example 5 | Example 6 |
|---|---|---|---|---|---|---|---|
| Yarns to be used | Warp | 11T/10 | 17T/18 | 24T/18 | 24T/26 | 15T/13 | 11T/24 |
| (dtex/f) | Weft | 11T/10 | 17T/18 | 24T/18 | 24T/26 | 15T/13 | 11T/24 |
| Viscosity | Warp | 0.85 | 0.87 | 0.87 | 2.8 | 3.1 | 0.85 |
| | Weft | 0.85 | 0.87 | 0.87 | 2.8 | 3.1 | 0.85 |
| Density (number | Warp | 245 | 220 | 180 | 170 | 230 | 245 |
| of yarns/inch²) | Weft | 245 | 200 | 172 | 160 | 230 | 245 |
| Basis weight | (g/m²) | 32 | 31 | 37 | 38 | 33 | 25 |
| Number of | Pieces/ | 60025 | 44000 | 30960 | 27200 | 52900 | 60025 |
| intersections | inch² | | | | | | |
| Unconstrained point | % | 29.2 | 4.5 | 10.6 | 33.3 | 29.2 | 29.2 |
| Tear strength | Warp | 10.5 | 9.1 | 10.1 | 10 | 8.5 | 8 |
| (N) | Weft | 12 | 8.2 | 11 | 11 | 9 | 7 |
| Abrasion strength | | 17000 | 16000 | 22000 | 33000 | 20000 | 8000 |
| Permeability | (cc/cm² · s) | 0.7 | 0.8 | 0.9 | 1.2 | 0.9 | 0.7 |
| Structure | | Ripstop | Ripstop | Ripstop | Twill | Ripstop | Ripstop |
| Silicone resin | | Yes | Yes | Yes | Yes | Yes | Yes |
| treatment | | | | | | | |
| Feeling | | 4.8 | 4.8 | 4.2 | 4 | 4.8 | 4.5 |
| Note | | | | | | | |

| | | | Comparative | Comparative | Comparative |
|---|---|---|---|---|---|
| | | Example 7 | Example 1 | Example 2 | Example 3 |
| Yarns to be used | Warp | 11T/10 | 17T/18 | 34T/24 | 11T/10 |
| (dtex/f) | Weft | 11T/10 | 17T/18 | 34T/24 | 11T/10 |
| Viscosity | Warp | 0.62 | 0.87 | 0.83 | 0.85 |
| | Weft | 0.62 | 0.87 | 0.83 | 0.85 |
| Density (number | Warp | 245 | 220 | 140 | 280 |
| of yarns/inch²) | Weft | 245 | 200 | 137 | 270 |
| Basis weight | (g/m²) | 30 | 30 | 40 | 34 |
| Number of | Pieces/ | 60025 | 44000 | 19180 | 75600 |
| intersections | inch² | | | | |
| Unconstrained point | % | 29.2 | 4.5 | 29.2 | 29.2 |
| Tear strength | Warp | 6 | 5 | 11 | 7 |
| (N) | Weft | 5.5 | 4 | 10.5 | 7 |
| Abrasion strength | | 6000 | 9000 | 55000 | 9000 |
| Permeability | (cc/cm² · s) | 0.7 | 0.8 | 1.8 | 0.5 |
| Structure | | Ripstop | Ripstop | Ripstop | Ripstop |
| Silicone resin | | Yes | No | Yes | Yes |
| treatment | | | | | |
| Feeling | | 4.5 | 2.4 | 3 | 2.8 |
| Note | | | | Poor | |
| | | | | slippage | |

### INDUSTRIAL APPLICABILITY

The woven fabric according to the present invention is a woven fabric that is very lightweight and thin and has high tear strength and abrasion strength, and is suitably used for sports garments, sleeping bags, futon tickings, and futon inner bags.

1. A thin woven fabric, comprising a thermoplastic synthetic fiber having a fineness of 5 to 30 dtexes disposed in at least a part of warps or wefts of the woven fabric, wherein a number of intersections between the warps and the wefts of the woven fabric is 23000 to 70000 pieces/(2.54 cm²), and silicone resin treatment is applied on the woven fabric.

2. The thin woven fabric according to claim 1, wherein the thermoplastic synthetic fiber is a polyester synthetic fiber or polyamide synthetic fiber having a single yarn fineness of 0.5 to 2.5 dtexes.

3. The thin woven fabric according to claim 1 or 2, wherein the thermoplastic synthetic fiber is a polyester fiber having an intrinsic viscosity [η] of 0.65 to 1.30.

4. The thin woven fabric according to claim 1 or 2, wherein the thermoplastic synthetic fiber is a polyamide fiber having a relative viscosity of 2.5 to 3.5.

5. The thin woven fabric according to any one of claims 1 to 4, wherein a basis weight of the woven fabric is 15 to 50 g/m².

6. The thin woven fabric according to any one of claims 1 to 5, wherein permeability of the woven fabric is 0.3 to 1.5 cc/cm²·sec.

7. The thin woven fabric according to any one of claims 1 to 6, wherein tear strength of the woven fabric is 8 to 20 N.

8. The thin woven fabric according to any one of claims 1 to 7, wherein a structure of the woven fabric is a ripstop structure.

9. The thin woven fabric according to claim 8, wherein a proportion of unconstrained points is 2 to 40% in the intersections between the warps and the wefts of the woven fabric.

10. The thin woven fabric according to any one of claims 1 to 9, wherein abrasion strength of the woven fabric is 10000 times or more.

11. The thin woven fabric according to any one of claims 1 to 10, wherein the silicone resin treatment is performed by a DIP-NIP method.

12. The thin woven fabric according to any one of claims 1 to 11, wherein an amount of the silicone resin to be attached is 0.1 to 10.0% by weight.
